(19) United States
(12) Patent Application Publication
(10) Pub. No.: US 2021/0147647 A1
(43) Pub. Date: May 20, 2021

(54) SUPERHYDROPHOBIC FILMS

(71) Applicants: Xiaoxiao Zhao, Baton Rouge, LA (US); Daniel Sang-won Park, Baton Rouge, LA (US); Michael Charles Murphy, Baton Rouge, NY (US)

(72) Inventors: Xiaoxiao Zhao, Baton Rouge, LA (US); Daniel Sang-won Park, Baton Rouge, LA (US); Michael Charles Murphy, Baton Rouge, NY (US)

(21) Appl. No.: 17/097,620

(22) Filed: Nov. 13, 2020

Related U.S. Application Data
(60) Provisional application No. 62/935,540, filed on Nov. 14, 2019.

(51) Int. Cl. C08J 7/04; C09D 7/40; C09D 7/62; C08K 3/36; C08K 5/54; C08K 9/06; C08L 33/12; C08L 69/00; C08J 7/056

(52) U.S. Cl. CPC C08J 7/0423; C09D 7/67; C09D 7/62; C08K 3/36; C08K 5/54; C08K 9/06; C08L 2203/16; C08L 69/00; C08J 7/056; C08K 2201/003; C08K 2201/011; C08L 2201/10; C08L 33/12

(57) ABSTRACT

Methods of preparing surfaces are disclosed relating to polymeric substrates that include the use of nano-scale silica particles, solvents and oligomers. Resulting surface preparations on those polymeric substrates may take the form of resilient superhydrophobic coatings having high optical transmittance.

This application claims the benefit of provisional application number 62/935,540 filed on Nov. 14, 2019 and entitled Superhydrophobic Films which is hereby incorporated by reference.

This invention was made with government support under grant number P41-EB-8935081-01 awarded by The National Institutes of Health. The government has certain rights in the invention.

Superhydrophobic films described herein may be used on polymer surfaces. Certain superhydrophobic films disclosed herein may strongly adhere to the underlying polymer surfaces.

### BRIEF DESCRIPTION OF THE DRAWINGS

FIG. 1 depicts the hydrophobic surface functional groups on a HS55 nanoparticle.

FIG. 2 depicts an epoxide and amino hydrogen reaction.

FIG. 3 depicts a vapor deposition configuration.

FIG. 4A shows the XPS spectra of S70 before and after PFTS modification.

FIG. 4B shows the XPS spectra of S200/HS55 films before and after PFTS modification.

FIGS. 5A-5C shows the fabrication procedures for various films.

FIG. 6 depicts static contact angles as a function of spin coating speed.

FIG. 7 depicts SEM and water droplet images for single particle size films and dual sized films.

FIG. 8 depicts SEM and water droplet images for single particle size films and dual sized films.

FIGS. 9A-9F depict surface topography of various coatings.

FIG. 9G shows the CA, CAH and RMS roughness of various coatings.

FIG. 10A shows hydroxyl groups being replaced by trimethylsiyl groups.

FIG. 10B shows hydroxyl groups forming covalent bonds after spin coating.

FIG. 11 shows SEM images of S200 films.

FIG. 12 shows the results of the tape peel test for films with epoxy resin.

FIG. 13 shows additional tape peel test results.

FIG. 14 shows additional tape peel test results.

FIG. 15 shows the experimental setup for a droplet impact test.

FIG. 16A shows transmittance spectra in visible wavelength for S70, HS55 and S200/HS55 films on PMMA.

FIG. 16B shows transmittance spectra in visible wavelength for S70, HS55 and S200/HS55 films on PC.

FIG. 17 depicts the covalent bonding of silica particles and substrates using silica-based oligomers.

FIG. 18 depicts the process of covalent bonding of silica particles and substrates using silica-based oligomers.

FIG. 19 depicts an SEM image of surface roughness associated with a tape peel test.

FIG. 20 depicts a tap water jet test and associated results.

FIG. 21 depicts a bending motion test and associated results.

FIG. 22 shows water contact angle as a function of the number of bending cycles.

FIG. 23 shows snapshots of the self-cleaning process of coatings.

FIG. 24 shows the surface morphology of the three types of films.

FIG. 25 shows transmittance spectra in visible wavelength for various films.

### DETAILED DESCRIPTION

### Example Set 1

Superhydrophobicity is defined by a static water contact angle (CA) greater than 150° and contact angle hysteresis (CAH), the difference between the advancing and receding CAs, less than 10°. It has been observed in natural systems including lotus leaves, insect legs and butterfly wings. Applications in medical and microfluidic devices may use these superhydrophobic surfaces to be transparent for optical detection and robust against moderate mechanical wear. Such surfaces have unique properties such as self-cleaning, anti-corrosion, anti-icing, anti-fogging, and drag reduction. Superhydrophobic surfaces, may have hierarchical roughness. Smooth surfaces with low surface energy may only achieve a CA of 120°. For surfaces with single-scale roughness, a water droplet resides in the Wenzel regime enabling hydrophobicity. For surfaces with hierarchical roughness, wetting behavior transitions from the Wenzel regime to the Cassie-Baxter regime where droplets sit on the peaks of surface features enabling extremely high-water repellent coatings. Optical transparency of rough, superhydrophobic surfaces is valuable in potential applications such as optical lenses, windows and solar cells. However, transparency and surface roughness are competing properties. Surfaces may be sufficiently rough to obtain superhydrophobicity, while being not too rough to avoid surface blurring caused by Mie scattering.

Fabrication of transparent, superhydrophobic coatings on polymers such as poly(methyl methacrylate) (PMMA) and polycarbonate (PC) may have a wide range of engineering applications. A simple, large area, low temperature method to produce superhydrophobic surfaces with high transparency and robustness is described herein. Epoxy resin was mixed with single and dual-sized hydrophobic fumed silica and pristine silica nanoparticles and the mixtures were spin coated on PMMA and PC substrates, followed by an oxygen plasma treatment and vapor deposition of 1H,1H,2H,2H-perfluorooctyltrichlorosilane, to produce robust, transparent, superhydrophobic surfaces. Epoxy resin was selected due to its high binding strength with multiple surface materials such as aluminum, steel and polyethylene terephthalate (PET). PMMA and PC polymers were selected due to their broad applications in engineering such as mixed-scale fluidic medical devices, aircraft windows and solar cell panels. Unlike glass and silicon, most polymers with low glass transition temperatures (T_{g}) cannot be annealed to firmly fix superhydrophobic coating films. The superhydrophobicity, robustness, and transparency of the single and dual-sized nanoparticle films on the polymer substrates were compared.

Fabricating artificial superhydrophobic surfaces with optical transparency may involve two steps: (1) hierarchical micro- or nanoscale surface roughness is created by either top-down methods including, spin coating, dip coating, and spraying of colloidal suspensions, or bottom-up methods such as, plasma etching, photolithography, and soft lithography; and (2) extremely high water repellent films are obtained by vapor deposition or plasma treatment of low surface energy materials, such as fluorine-containing organic molecules. Among them, it is especially challenging to fabricate robust, transparent, superhydropobic particle films on polymer surfaces because pre- and post-surface treatments with chemical solvents could potentially corrode the substrate, affecting the optical properties. For example, pre-cleaning with a piranha solution (H₂O₂/H₂SO₄) is commonly used to create a range of oxygen-containing groups, such as —OH and —COOH, to facilitate subsequent surface hydrophobization. This process could severely damage organic polymer substrates. Also, high temperature thermal annealing, commonly used for inorganic substrates such as glass and silicon in order to enhance the adhesion between nanoparticle films and substrates, is not applicable for many polymers due to their low glass transition temperatures (T_{g}).

PMMA (Cope Plastics, Alton, Ill., 100×100 mm surface area, 3 mm thick) and PC (SABIC Innovative Plastics, Houston, Tex., 100×100 mm surface area, 3 mm thick) were used as spin-coating substrates. Diglycidyl ether of bisphenol A (DGEBA) was purchased from Electron Microscopy Sciences (Hatfield, Pa.). 4,4′-diaminodiphenylmethane (DDM) was brought from TCI America (Portland, Oreg.). Anhydrous ethanol, 200 proof, was obtained from Decon Laboratories (Montco, Pa.). Tetraethyl orthosilicate (TEOS) was supplied by Acros Organics (98%®) (Geel, Belguim). Ammonia, 28-30%®, was purchased from VWR International (Radnor, Pa.). Hydrophobic silica nanoparticles (55±15 nm) were purchased from Evonik Industries (AEROSIL RX 55, Mobile, Ala.). 1H,1H,2H,2H-perfluorooctyl-trichlorosilane (PFTS), 97%, was obtained from BeanTown Chemical (Hudson, N.H.). Methylene Blue was purchased from Aldon Corporation (Avon, N.Y.).

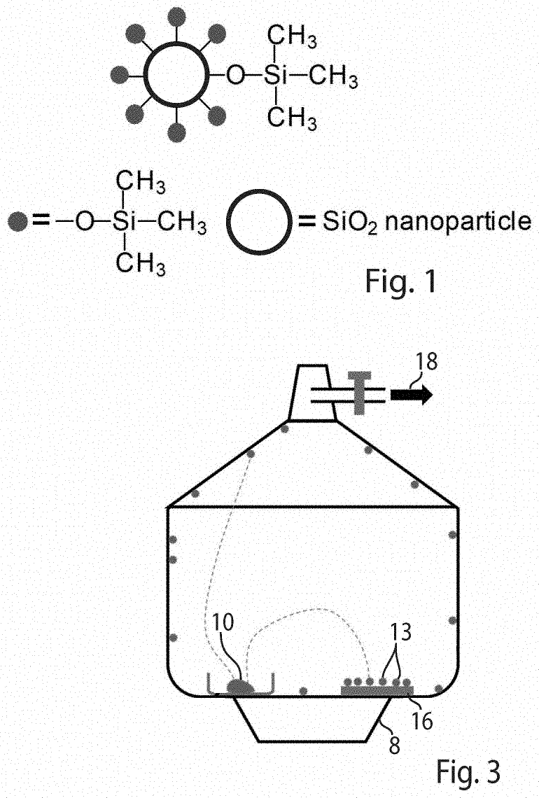

Silica particles of 30 nm (S30), 70 nm (S70) and 200 nm (S200) were synthesized by the single step Stöber method. For S200 microparticles, 12 ml TEOS was added to a flask containing a solution of 200 ml ethanol and 24 ml ammonia. (See Table 1) The mixture was magnetically stirred at 600 rpm for 18 h at room temperature. The resulting microparticles were centrifuged and vacuum-dried overnight. As shown in Table 1, S70 and S30 nanoparticles were prepared with the same procedure by varying the concentration of ammonia and TEOS. HS55 nanoparticles were purchased with hydrophobic functional groups as depicted in FIG. 1 which depicts the hydrophobic surface functional groups on a HS55 nanoparticle.

TABLE 1
Chemicals for preparation of silica nanoparticles.

| Silica size/nm | Ethanol/mL | Ammonia/mL | TEOS/mL |
|---|---|---|---|
| 200 | 200 | 24 | 12 |
| 70 | 200 | 10 | 5 |
| 30 | 200 | 8 | 4 |

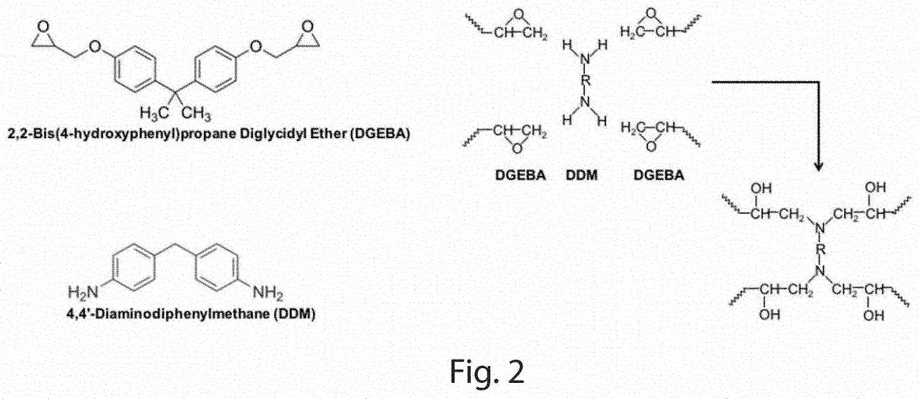

Epoxy resin was prepared by mixing epoxy (DGEBA) and amine curing agent (DDM) with a specific molar ratio. The DGEBA molecule has two epoxides and the DDM molecule has four amino hydrogens (—NH), so that two DGEBA molecules equivalently react with each DDM molecule. The molar ratio of DGEBA and. DDM was controlled at 2:1 to ensure the complete reaction of epoxide and amino hydrogen (FIG. 2). To obtain this molar ratio, 100 mg of DGEBA and 29 mg of DDM were added to 20 ml ethanol. In addition, the reaction of DGEBA and DDM created hydroxyl groups, to which EFTS molecules can be grafted in the subsequent vapor deposition process. FIG. 2 shows how two DGEBA molecules react equivalently with one DDM molecules, creating hydroxyl groups.

TABLE 2
Spin coating mixtures and speed for single-sized S70, HS55,
S200 and dual-sized S200/S30, S200/S70, S200/HS55 films.

| | | | | | | | Spin |
|---|---|---|---|---|---|---|---|
| | | | | | | | coating |
| Coating | S200/ | S70/ | HS55/ | DGEBA/ | DDM/ | Ethanol/ | speed/ |
| films | mg | mg | mg | mg | mg | ml | rpm |
| S70 | 0 | 500 | 0 | 50 | 14.5 | 20 | 3000 |
| HS55 | 0 | 0 | 500 | 50 | 14.5 | 20 | 3000 |
| S200 | 250 | 0 | 0 | 100 | 29 | 20 | 1500 |
| S200/ | 250 | 0 | 0 | 100 | 29 | 20 | 1500 |
| S30 | | | | | | | |
| S200/ | 250 | 500 | 0 | 100 | 29 | 20 | 1500 |
| S70 | | | | | | | |
| S200/ | 250 | 0 | 500 | 100 | 29 | 20 | 1500 |
| HS55 | | | | | | | |

Regarding the method for surface fabrication, the process sequence for obtaining both single and dual-sized films was the same for both PMMA and PC substrates. Silica nanoparticles were dispersed in a mixture of epoxy resin (DGEBA, DDM) and ethanol. After sonication for 30 min, the mixture was spin coated using a Bidtec SP100 spin coater onto the PMMA and PC substrates. Optimal particles concentration, epoxy resin concentration and spin coating speed were identified for fabricating films including single-sized HS55, S70, and S200 particles, and dual-sized S200/S30, S200/S70, and S200/HS55 particles (See Table 2). After spin coating, the polymer substrates were put in a 60° C. oven for 5 h to cure the epoxy resin.

For surface hydrophobilization, the substrates were treated with oxygen plasma (30 W, 0.15 Torr, Harrick Plasma PDC-32G, Ithaca, N.Y.) for 3 min. As shown in FIG. 3, PFTS with a volume of 0.1 ml was vapor-deposited on the substrates in a vacuum desiccator for 30 min. FIG. 3 is a schematic of vapor deposition of PFTS in a vacuum desiccator. In FIG. 3, Desiccator 8 distributes Fluorosilane droplet 10 including placing Deposited molecules 13 on Polymer substrate 16. A Vacuum 18 is pulled on Desiccator 8 during this process.

The static CA, CAH and sliding angle (SA) were measured with a VCR Optima goniometer from AST Products, Inc., Billerica, Mass. and using a droplet shape software from VCA Optima XE, AST Products, Inc., Billerica, Mass.. Static CA was measured with droplets of 5 μL distilled water deposited onto samples with a microsyringe. CAH was calculated from the difference between the advancing and receding CAs, which was achieved by adding and removing water from the sample surface. SA was measured using 10 μL droplets by tilting the goniometer sample stage at a rate of 1 deg/s until the droplets rolled off the surface. Five different positions on each sample were measured.

The morphology of the as-prepared nanoparticle films was imaged using a Field Emission Gun Scanning Electron Microscope (FEG-SEM), namely the Quanta 3D DualBeam from Hillsboro, Oreg.. Before SEM imaging, the samples were sputter-coated with a EMS550X sputter coater by Electron Microscopy Sciences, Hatfield, Pa. with a layer of roughly 10 nm platinum to improve electrical conductivity and reduce the charging effect.

The surface topography and root mean square (RMS) roughness of the S70, HS55 and S200/HS55 films were characterized by Atomic force microscopy (AFM). Samples were imaged in air at room temperature and humidity with a 5500 Scanning Probe Microscope—available from Agilent Technologies, Santa Clara, Calif.—operating in intermittent contact mode, typically referred to as an AC mode, with a scan rage of 5μm×5 μm at 512×512 pixels and a scan rate of 0.5 Hz. The intermittent contact was selected to avoid the detachment of nanoparticles during measurement. Tapping-mode silicon cantilever probes—of the type PPP-RT-NCHR available from NanoSensors, Neuchatel, Switzerland with a nominal resonance frequency of 330 kHz, a nominal constant force of 42 N/m, and a curvature radius of less than 10 nm were used. Image processing and analysis, consisting of background correction, were carried out using Gwyddion 2.53 from the Dept. of Nanometrology, Czech Metrology Institute, Brno, Czech Republic.

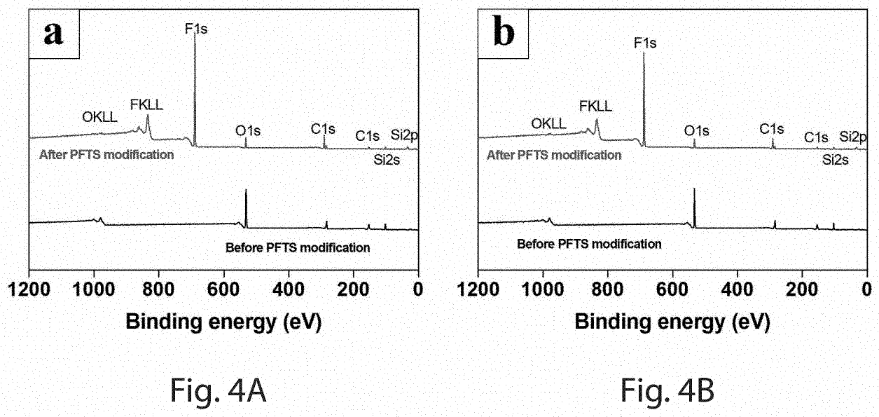

X-ray photoelectron spectroscopy (XPS) analysis—using an ESCA 2SR from Scienta Omicron, US—was used to detect the chemical depositions of the coating surfaces. XPS spectra were measured before and after PFTS modification. The XPS spectra before and after PFTS modification for S70 and HS55/S200 are shown. Before the PFTS modification, the surface chemical elements were mainly composed of Si, O and C, indicating that the surface chemical groups were —OH and that this surface was very hydrophilic. After PFTS modification, a strong fluorine peak around 688 eV is observed, indicating that the films were successfully covered by PFTS. Because the characteristic range of XPS is 3 to 8 atomic layers (1-3 nm), a large portion of oxygen elements covered below the long PFTS molecule chains cannot be detected, resulting in a dramatic decrease of oxygen peaks after PFTS modification. As a result, both S70 and S200/HS55 films turned from highly hydrophilic to superhydrophobic after PFTS modification. FIG. 4A shows the XPS spectra of S70 before and after PFTS modification and FIG. 4B shows S200/HS55 films before and after PFTS modification.

In the droplet impact test, 0.1 mL water droplets were released from a height of 100 mm above the sample surface tilted at 10°. The water droplet was dripped at rate of 1 droplet per second for 5 to 30 min. In the tape peeling test, a pressure of 100 kPa was applied on Scotch tape—Scotch™ MultiTask Tape from 3M, St. Paul, Minn.—to ensure a full contact with the sample surface, and the tape was immediately peeled off. The static CAs were measured before and after the tape peel test to assess any changes as a result of the tape peeling.

Optical transmittance measurements were performed using a Thermo Electron Helios UV-Vis spectrophotometer from Thermo Electron Corp., Madison, Wis.. The transmittance percentage of one-sided coatings were based on the uncoated substrates in visible wavelength range (400-700 nm).

Among all six types of coating films, single-sized S70, HS55 films and dual-sized S200/HS55 films were selectively studied due to their high water CAs. Table 3 compares the robustness, hydrophobicity and transparency of HS55, S70 and S200/HS55 films. The HS55, S70 and S200/HS55 films have their specific limitation in robustness, superhydrophobicity and optical transmittance, respectively. The HS55 films have limited robustness due to the thin epoxy resin bridges on HS55 nanoparticles. The S70 films have limited superhydrophobicity due to the single scaled surface roughness. The dual-sized S200/HS55 films have low optical transmittance due to their high film thickness.

TABLE 3
Robustness, superhydrophobicity and transparency for
three types of coating films on PMMA/PC substrates.

| | Robustness | | | | | Optical |
|---|---|---|---|---|---|---|
| | Droplet | Tape | Superhydrophobicity | | | trans- |
| Coating | impact test | peeling test | CA/° | CAH/° | SA/° | mittance |
| S70 | Pass | Pass | 147 ± 3 | 25 ± 18 | 28 ± 13 | 84-97% |
| HS55 | Pass | Not pass | 158 ± 2 | 6 ± 2 | 5 ± 3 | 92-99% |
| S200/HS55 | Pass | Pass | 162 ± 3 | 3 ± 2 | 5 ± 3 | 61-92% |

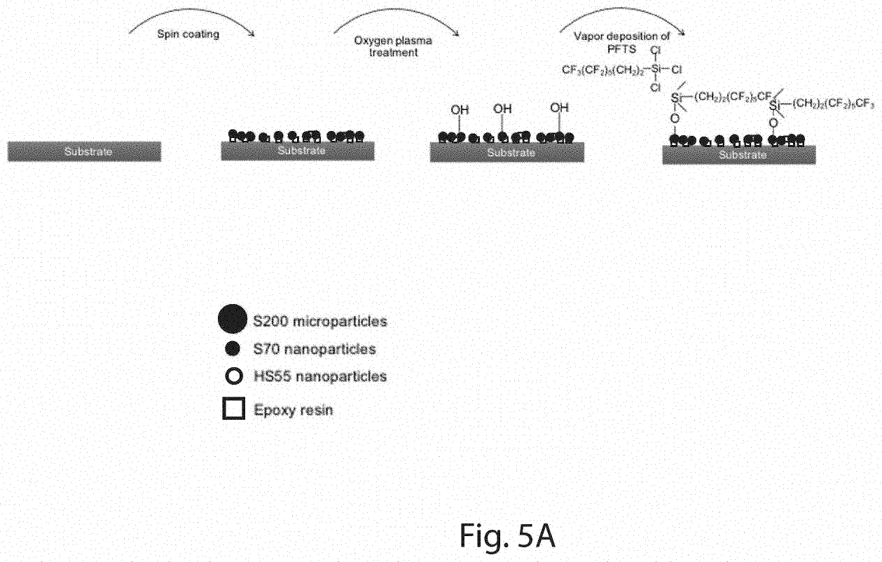

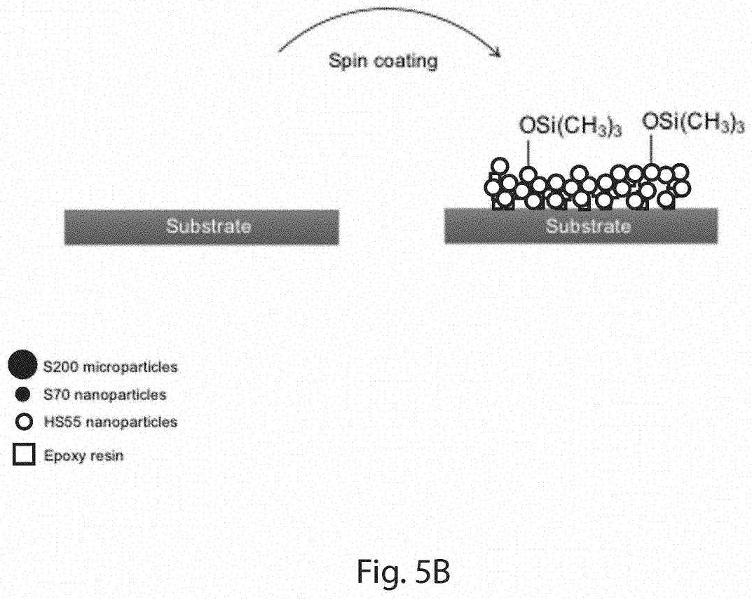

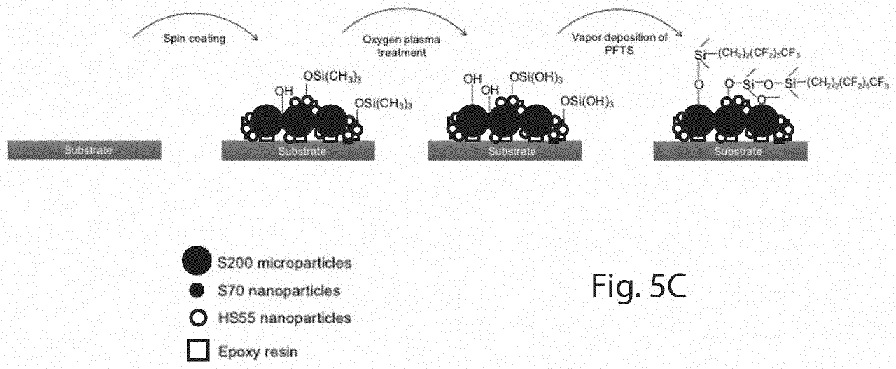

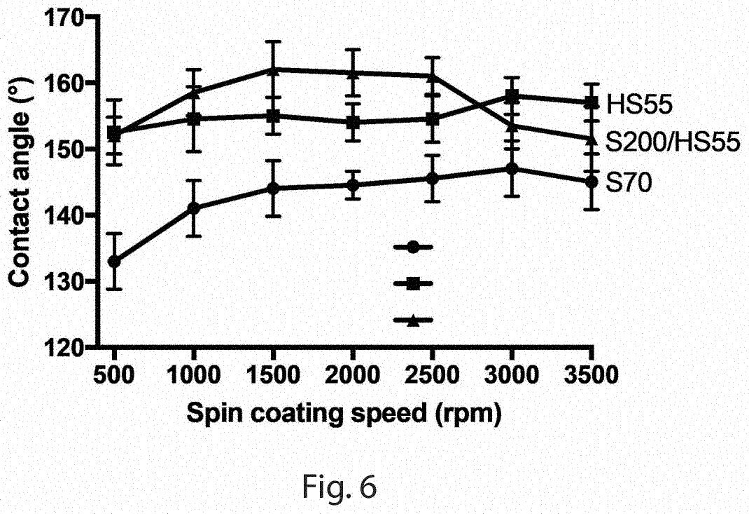

FIGS. 5A-5C shows the fabrication procedures of single-sized S70, HS55 films and dual-sized S200/HS55 films on PMMA or PC substrates. Due to the hydrophobicity of HS55 nanoparticles, only a single spin coating step was sufficient to obtain superhydrophobic HS55 films, while S70 and S200 films required following vapor deposition procedure to lower surface energy. FIG. 6 shows the static CAs of S70, HS55, S200/HS55 films as a function of spin coating speed on PMMA and PC. FIGS. 5A-C show schematics of fabrication processes for the fabrication procedures for single-sized S70 (FIG. 5A); HS55 (FIG. 5B); and dual-sized S200/HS55 films (FIG. 5C).

FIG. 6 depicts static contact angles (CAs) as a function of spin coating speed for S70, HS55, and S200/HS55 films on PMMA substrates.

The spin coating speed was 3000 rpm for S70 and HS55 films, and 1500 rpm for S200 films. The high spin coating speed at 3000 rpm for S70 and HS55 films prevented agglomeration of nanoparticles to improve the film roughness. However, such high spin coating speed made the epoxy resin bridges thin and fragile that reduced the film robustness. However, a low spin coating speed at 1500 rpm for S200 films resulted in thick epoxy resin bridges between particles that improved the film robustness.

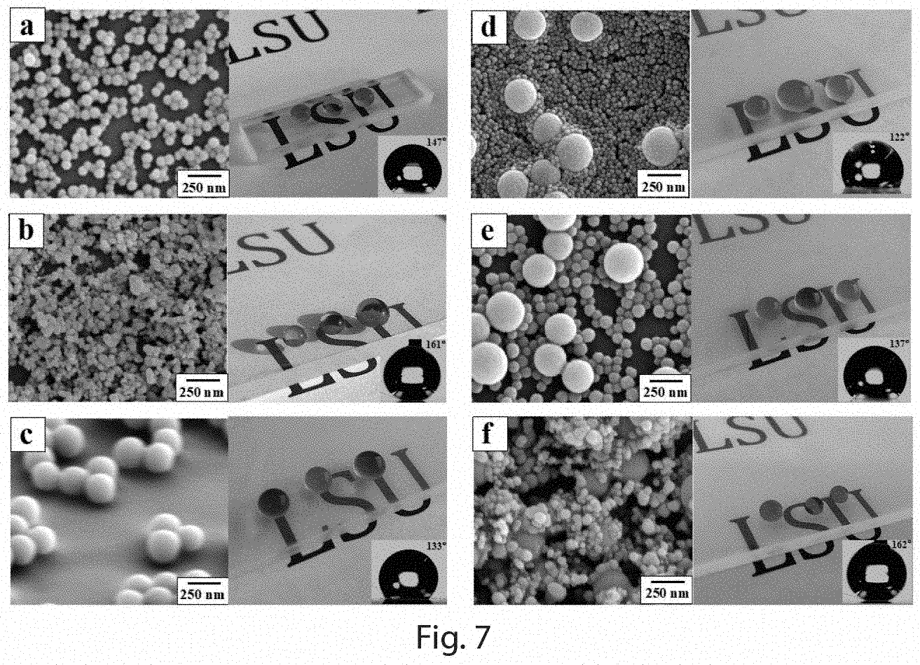

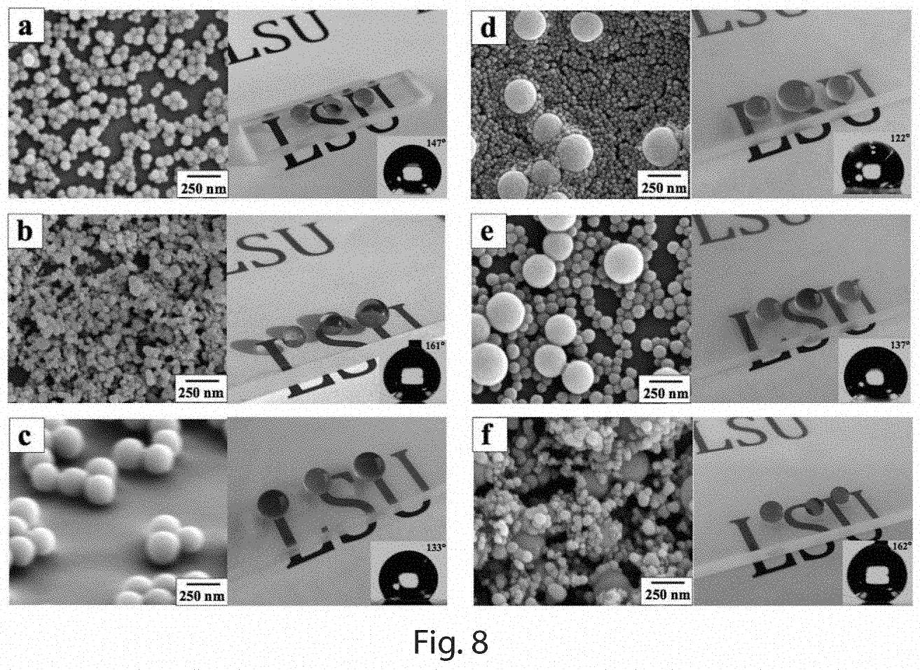

The spin coating speed was 1500 rpm for dual-sized S200/S30, S200/S70 and S200/HS55 films. On both PMMA and PC substrates, only the dual-sized S200/HS55 films created hierarchical surface structures (FIG. 7, FIG. 8). The dual-sized S200/HS55 films allow thick epoxy resin bridges to form robust backbones, where HS55 nanoparticles can be attached to form hierarchical structures.

FIG. 7 depicts SEM and water droplet images for single particle size films: (a) S70; (b) HS55; (c) S200 and dual sized films: (d) S200/S30; (e) S200/S70; (f) S200/HS55 on PMMA substrates. Methylene blue was added to water droplets to aid visual clarity.

FIG. 8 depicts SEM and water droplet images for single particle size films: (a) S70; (b) HS55; (c) S200 and dual sized films: (d) S200/S30; (e) S200/S70; (f) S200/HS55 on PC substrates. Methylene blue was added to water droplets to aid visual clarity.

The epoxy resin concentration was selected as 5 mg/mL for single-sized S70, HS55 films, and 10 mg/mL for single-sized S200 and dual-sized S200/S30, S200/S70 and S200/HS55 films. Due to the small size of single-sized S70 and HS55 particles, a lower epoxy resin concentration can prevent surface smoothing effect.

When the epoxy concentration is too low, the epoxy resin bridges became thin and fragile, resulting in less robust coating films. For example, we have shown the epoxy bridges of S200 films become thinner in SEM images when decreasing epoxy resin concentration from 20 mg/mL to 10 mg/mL. Also, most particles detached on S200/HS55 films after tape peeling test when decreasing epoxy resin concentration from 10 mg/mL to 5 mg/mL On the contrary, when the epoxy concentration is too high, it could smooth the coating films by filling in valleys between silica particles. Therefore, the epoxy resin concentration should be high enough to ensure high robustness while not too high to smooth the coating films. The epoxy resin concentration also has an effect on optimal spin coating speed. A high concentration of epoxy resin increases the viscosity of epoxy-silica mixtures, which requires a higher spin coating speed to uniformly spread the films.

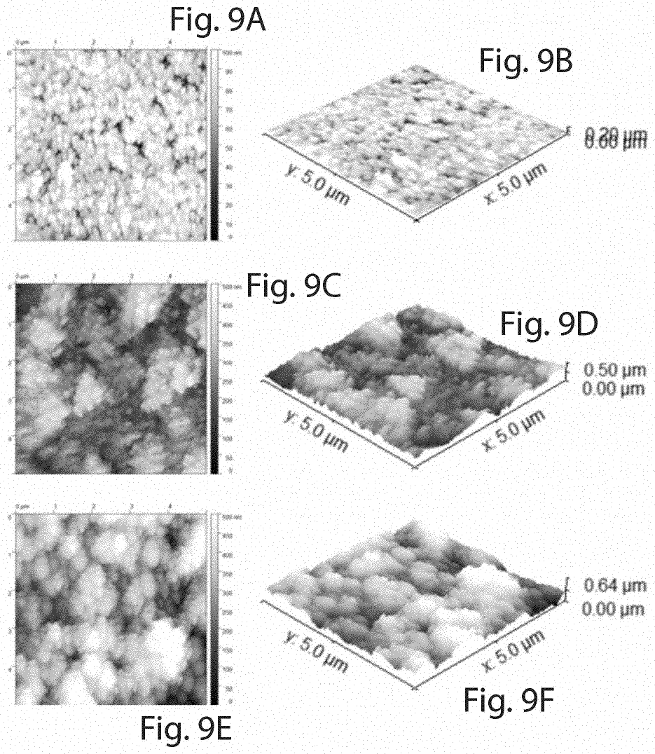

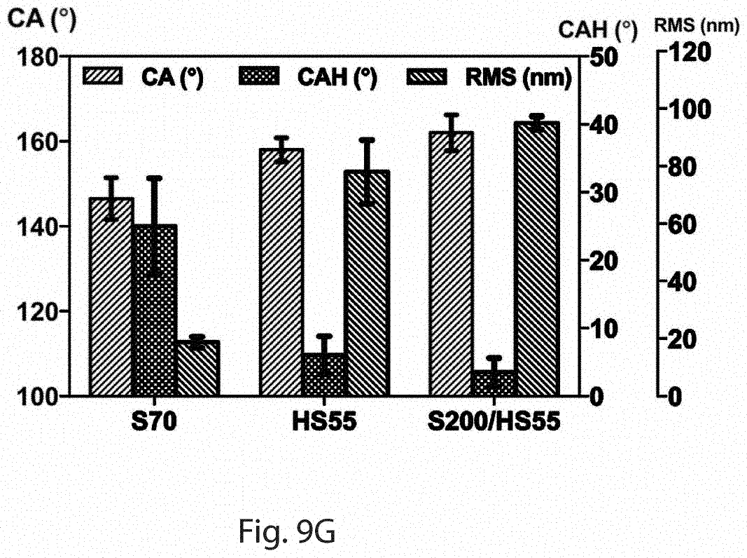

The surface topography and root mean square (RMS) roughness of the S70, HS55 and S200/HS55 films were characterized by Atomic force microscopy (AFM) (FIG. 9). Samples were imaged in air at room temperature and humidity with a S500Scanning Probe Microscope from Agilent Technologies, Santa Clara, Calif.—operating in intermittent contact mode, typically referred to as an AC mode, with a scan rage of 5 μm×5 μm at 512×512 pixels and a scan rate of 0.5 Hz. The intermittent contact was selected to avoid the detachment of nanoparticles during measurement. Tapping-mode silicon cantilever probes—type PPP-RT-NCHR from NanoSensors, Neuchatel,—Switzerland with a nominal resonance frequency of 330 kHz, a nominal constant force of 42 N/m, and a curvature radius of less than 10 nm were used. Image processing and analysis, consisting of background correction, were carried out using Gwyddion 2.53 from the Dept. of Nanometrology, Czech Metrology Institute, Brno, Czech Republic.

FIGS. 9A-F depict AFM images of S70 film in 9A and 9B, HS55 film in 9C and 9D and S200/H555 film in 9E and 9F on PMMA substrates. FIG. 9G shows the CA, CAH and RMS roughness of S70, HS55 and S200/HS55 films.

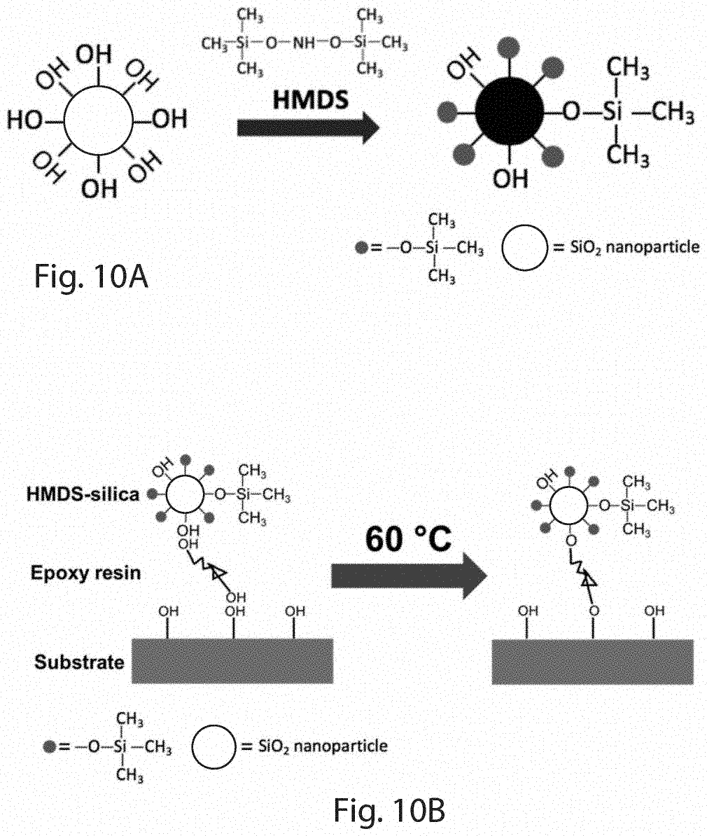

Pristine silica particles have hydroxyl surface functional groups, which can form chemical bonds with epoxy resin. Therefore, with epoxy resin added, the pristine silica particles achieved high adhesion strength on PMMA substrates. However, as shown in FIG. 10A, most hydroxyl groups on silica particles were replaced by trimethylsiyl groups after HMDS surface modification, while only a small portion of the hydroxyl groups remained. The remaining hydroxyl groups can still form covalent bonds after spin coating and curing as can be seen in FIG. 10B. However, due to the low density of the hydroxyl groups on HMDS modified silica, adhesion strength was lower with epoxy resin than with pristine silica particles. Due to the reduced adhesion strength, many HMDS modified silica nanoparticles were detached from the HS55 films after the tape peel test.

FIG. 10A shows the HMDS modification of pristine silica particles, and FIG. 10B shows the covalent bond formed between HMDS-silica and epoxy resin, substrate and epoxy resin.

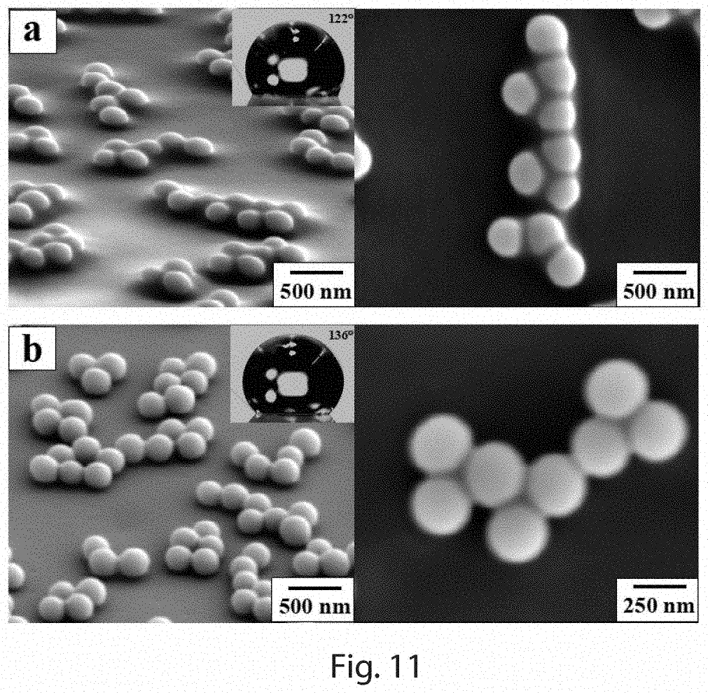

FIG. 11 shows SEM images of S200 films spin coated onto PMMA with DGEBA concentration of (a) 20 mg/mL and (b) 10 mg/mL. Insets show the water contact angle of 122° (a) and 136° (b) after low energy fluorosilane treatment.

For both the S70 and dual-sized S200/HS55 films, the tape peel tests were conducted before PFTS deposition because PFTS prevented the adhesion of tape on the surfaces. Without epoxy resin, the HS55 particles were attached to the surface only by van der Waals interactions. The peeled tape area of such HS55 films were almost particle free and the static CAs significantly decreased from 161° to 73°.

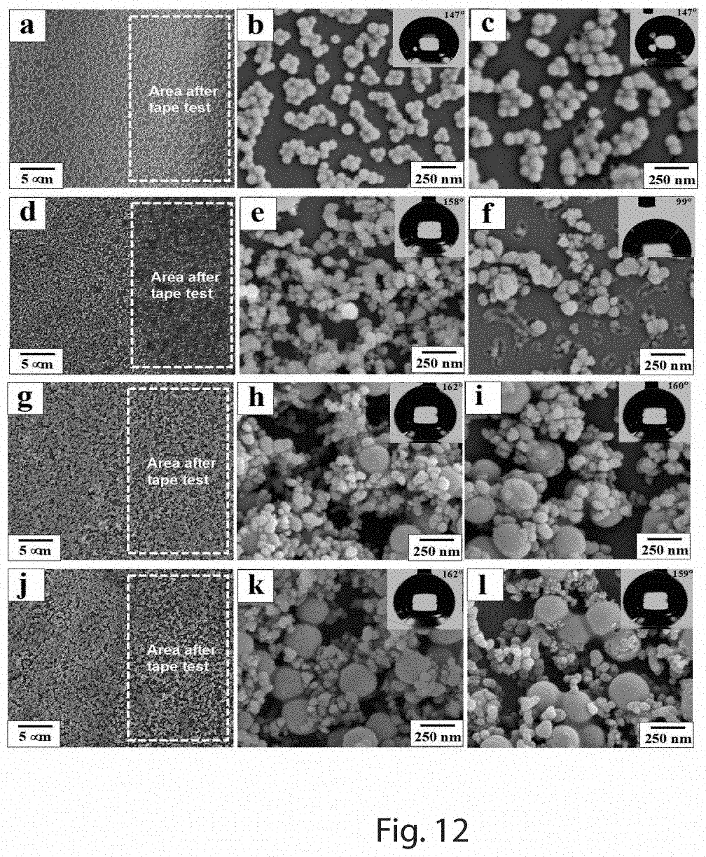

Results of the tape peel test for films with epoxy resin on PMMA and PC are shown in FIG. 12. For the S70 films, FIG. 12 image c shows that only one or two nanoparticles (indicated by the arrows) detached over a 1.5×1.3 μm² surface area, and the static CAs were essentially unchanged after removal of the tape. For the HS55 films, FIG. 12 image f shows that a few nanoparticles remain attached after the removal of the tape and the mean static CA decreased significantly from 158°±5° to 99°±11°. More nanoparticles were detached from the HS55 films compared to the S70 films, after the tape peel test. This may be due to the methyl groups on the HS55 lowering the adhesion strength between the nanoparticles and the epoxy resin.

FIG. 12 image i and 1 show the surface morphologies of the dual-sized S200/HS55 films after the tape peel test on PMMA and PC, respectively. A small quantity of the HS55 nanoparticles detached from the films exposing some hydrophilic cavities. However, the surface superhydrophobicity was not affected by these hydrophilic cavities and the surfaces still maintained their static CAs, which only decreased by 2.5°±0.5° for both PMMA and PC. One possible explanation is that the water droplets in the contact angle measurements do not enter or contact the cavities and the wetting behavior still remains in the Cassie-Baxter regime.

FIG. 12 shows SEM images of dual-sized S200/HS55 films in image a with DGEBA concentration of 5 mg/mL, and close-up views (image b) before and (image c) after the tape peel test on PMMA.

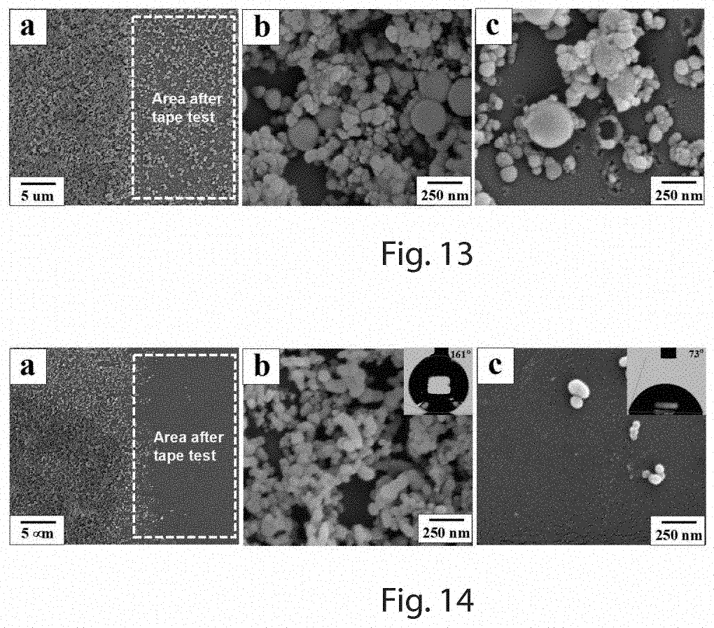

The optimal epoxy resin concentration was selected as 5 mg/mL for single-sized S70, HS55 films, and 10 mg/mL for single-sized S200 and dual-sized S200/S30, S200/S70 and S200/HS55 films. Due to the small size of the single-sized S70 and HS55 particles, a lower epoxy resin concentration was necessary to prevent completely embedding the particles in the epoxy layer. When the epoxy concentration was too low, the epoxy resin bridges became thinner and more fragile, resulting in less robust films. More particles detached from the S200/HS55 films after the tape peel test when the epoxy resin concentration was decreased from 10 mg/mL to 5 mg/mL (see FIG. 13). Higher epoxy concentrations produced smooth coating films.

FIG. 13 show transmittance spectra in the visible wavelengths for S70, HS55 and S200/HS55 films on: PMMA (image a); and PC substrates (image b). Transmittance percentage is determined relative to pristine PMMA and PC samples.

Films for the both the single-sized particles and dual-sized films with pristine nanoparticles show low surface roughness. However, the dual-sized S200/HS55 films have thick epoxy resin bridges, which were robust backbones for the attachment of the HS55 nanoparticles, showed hierarchical surface structures. The robustness of the epoxy bridges was affected by the epoxy resin concentration and spin coating speed. Low epoxy resin concentration and high spin coating speeds yielded thin, fragile epoxy resin bridges, which reduced the film robustness. However, a high epoxy resin concentration and low spin coating speed resulted in thick epoxy resin bridges with improved the film robustness, while compromising the surface roughness. Moreover, too high of epoxy resin concentration increased the viscosity of the epoxy-silica mixtures, which requires higher spin coating speed to evenly distribute the nanoparticles and to achieve uniform surface coverage. For HS55 nanoparticles spin coated on PMMA without epoxy resin, the particles were almost completely removed after tape peel test as shown in FIG. 14.

FIG. 14 shows SEM images of (a) HS55 films without epoxy resin (image a), and close-up views before (image b) and after tape test (image c) on PMMA.

The surface superhydrophobicity for both the single-sized and dual-sized particle films was not affected by the droplet impacts. The epoxy resin was essential to the films' resistance to the droplet impact (FIG. 15). On both the PMMA and PC substrates, the superhydrophobicity was maintained even after 30 min of droplet impacts.

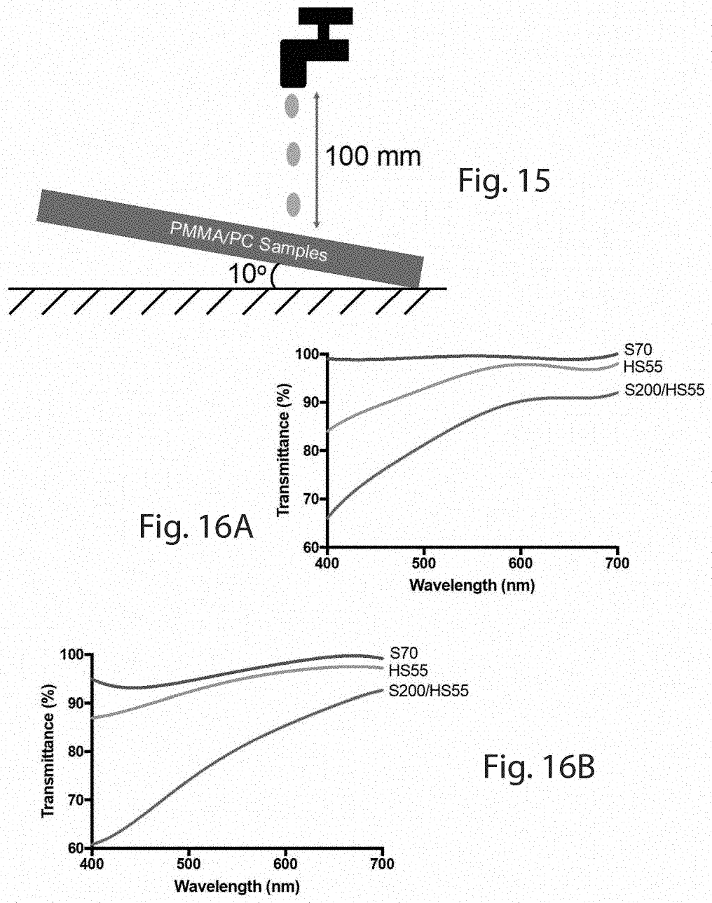

At visible light wavelengths of 400-700 nm, the silica oxide particles have high transmittance due to a low refractive index (n=1.5) and low absorption due to a short band gap wavelength (138 nm). The refractive index of epoxy resin is roughly 1.57, Small surface features have higher visible light transparency. Transmittance increases as a function of wavelength for both dual-sized and HS55 films because the difference between the particle size and the wavelength is increasing. As shown in FIG. 16, on both PMMA and PC substrates, the S70 films have the highest optical transmittance while the S200/HS55 films have the lowest optical transmittance. The dual-sized S200/HS55 films have higher thickness and thus higher surface roughness than the single-sized particle films which contributes to the lower optical transmittance. Although the particle size for the HS55 films is smaller than the S70 films, the latter have higher optical transmittances. This may be due to the porous structure of the HS55 films which produced greater surface roughness.

FIG. 15 shows a schematic of a droplet impact test on PMMA/PC samples.

FIG. 16A shows transmittance spectra in visible wavelength for S70, HS55 and S200/HS55 films on PMMA and FIG. 16B shows transmittance spectra in visible wavelength for S70, HS55 and S200/HS55 films on PC. The graph shows the transmittance percentage with respect to the pristine PMMA and PC.

A versatile spin coating technique was used to create robust, transparent, superhydrophobic surfaces on PMMA and PC substrates with silica particles and epoxy resin. Single-sized S70, HS55, S200 films and dual-sized S200/S30, S200/S70, S200/HS55 were fabricated. Among all six types of coating films, the HS55, S70 and S200/HS55 films have been extensively studied due to their high CAs. The HS55 films did not require post-treatment with low energy materials, while they had limited film robustness. The S70 films achieved the maximum robustness and optical transmittance, while they were only highly hydrophobic, not superhydrophobic. The S200/HS55 films, which combined the advantages of HS55 and S70 films, achieved both superhydrophobicity and high robustness. The resulting surface films had a water contact angle of 162°±3° and a sliding angle of 3°±2°. The combination of hydrophobic fumed silica and pristine silica played an important role in creating the hierarchical structures and improving the mechanical robustness. However, S200/HS55 films had the lowest optical transmittance due to their hierarchical high surface roughness. The S70/HS55 films were highly transparent with transmittance of 82.5%±16% on PMMA and 80.5%±18.5% on PC in the visible region. Epoxy resin was added in silica particles to improve the adhesion between the silica particles and the polymer substrates. All coating films showed resistance to droplet impacts, and S70, S200/HS55 maintained static CAs after the tape peel test, indicating strong bonding by the epoxy resin. The coatings remained superhydrophobic after 30 min of droplet impacts or 3 cycles of tape peeling. This study indicates that the robustness of transparent superhydrophobic surfaces can be improved by using epoxy resin as a binder for hydrophobic silica particles (HS55 films), and the robustness can be even further improved by incorporating both pristine and hydrophobic silica particles (S200/HS55 films).

### Example Set 2

Poor adhesion of coating films is a common challenge in superhydrophobic coatings on polymers. For polymers with low glass transition temperatures, it may be desirable to have a low temperature coating strategy to fabricate robust superhydrophobic films. Transparency of superhydrophobic surfaces has wide potential application in windows, digital screens, solar panels, and other technology areas. Reducing the dimensions of the surface structure is a common approach to improve optical transmittance while maintaining sufficient surface roughness for superhydrophobicity. However, rough surfaces with structure size below 20 nm may lose superhydrophobicity due to the effect of long-range forces.

Epoxy resins described above may be used for enhancing the adhesion between silica nanoparticles and plastic substrates. However, since the epoxy resin is organic, it may cause biocompatibility for applications in microtluidics chips. Moreover, the binding between epoxy resin and hydrophobic silica particles was not strong enough for repeated peeling test. Therefore, it would be ideal to replace that epoxy resin bridge with inorganic silica bridges, which improves the binding with silica nanoparticles. Also, the inorganic silica bridges would not have any biocompatibility issue for application in microfluidic systems.

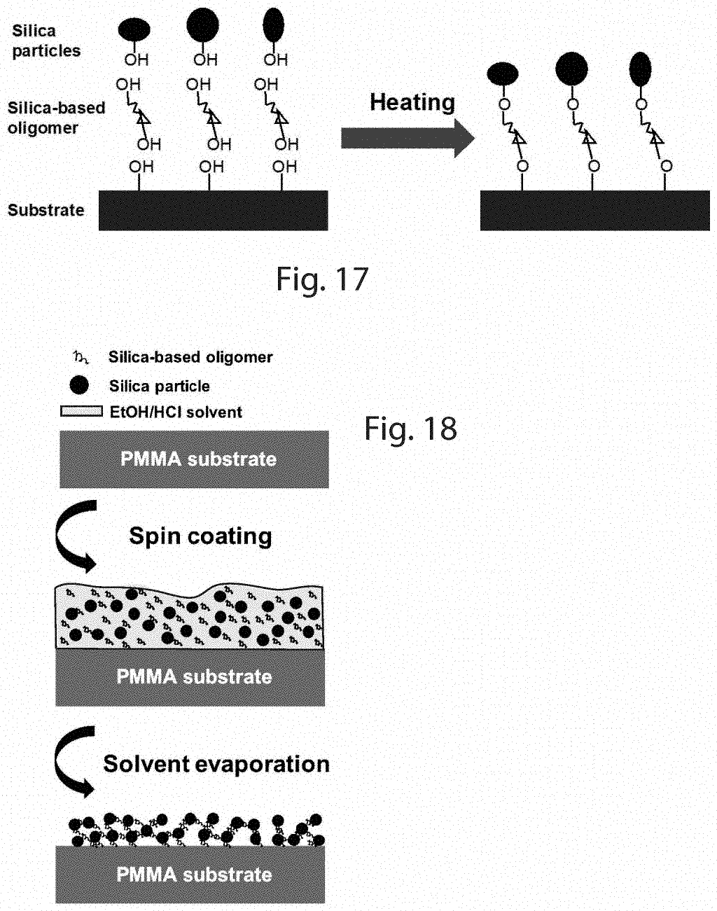

A facile method for fabricating robust, transparent, superhydrophobic films on polymer substrates was developed. The robustness of the coating was improved by covalent bonding of silica particles and substrates using silica-based oligomers (FIG. 17). A mixture of silica particles (70 nm, 400 nm, 650 nm) and silica-based oligomers was spin coated on polymer substrates, followed by oxygen plasma treatment and vapor deposition of 1H,1H,2H,2H-Perfluorodecyltriethoxysilane (FDTS). After spin coating and solvent evaporation, the mixture of acid sols and silica particles was strongly adhered onto substrates (FIG. 18). The morphology of the silica-oligomer hybrid film was analysed, and the static CAs and sliding angles were measured for silica particles of 70 nm, 400 nm, and 650 nm, respectively. This study provides a practical solution to improve the adhesion of robust, transparent, superhydrophobic films on polymers in ambient conditions.

FIG. 17 is a schematic of silica-based oligomers binding silica particles onto substrates.

FIG. 18 depicts spin coating and solvent evaporation of a mixture of acid sols and silica particles onto substrates.

Sol-gel processes include dispersion of inorganic particles in organic oligomer solutions to form hybrid inorganic-organic networks linked by hydrogen or covalent bonds. For superhydrophobic coatings, the inorganic particles determine the coating's transparency and hardness, while the organic oligomers determine the coating's porosity and adhesion strength. Silica sols may silica-based oligomers with abundant hydroxyl groups. Those hydroxyl groups form Si—O—Si bonds between the coatings and substrates to improve surface adhesion. Heat treatment generates porosities on coating films to improve the surface roughness.

Poly(methyl methacrylate) (PMMA) (Cope Plastics, 100×100 mm surface area, 0.75 mm thick, Alton, Ill.) was used as spin-coating substrates. Anhydrous ethanol was obtained from Decon Laboratories (200 proof) (Montco, Pa.). Tetraethyl orthosilicate (TEOS) was supplied by Acros Organics (98%) (Leel, Belguim). Ammonia (28-30%) and hydrochloric acid (HCl) (36.5-38%) were purchased from VWR International (Radnor, Pa.). FDTS was obtained from Gelest, Inc (Morrisville, Pa.). Methylene Blue was purchased from Aldon Corporation (Avon, N.Y.).

Silica particles of 70 nm (S70), 400 nm (S400) and 650 nm (S650) were synthesized using the Stöber method. For S70 microparticles, 10 nil TEOS was added to a flask containing a solution of 200 ml ethanol and 24 ml ammonia. The mixture was magnetically stirred at 600 rpm for 18 h at room temperature. The resulting microparticles were centrifuged and vacuum-dried overnight. Table 4 shows the same procedure was used for S400 and S650 nanoparticles by varying the concentrations of ammonia and TEOS.

TABLE 4
Chemicals used for preparation of silica nanoparticles.

| | Ethanol/mL | Ammonia/mL | TEOS/mL |
|---|---|---|---|
| 70 nm | 200 | 10 | 5 |
| 400 nm | 200 | 15 | 7.5 |
| 650 nm | 200 | 20 | 10 |

Silica-oligomer hybrid films were spin coated onto the PMMA substrates. The spin coating mixture composed of silica particles and a suspension of silica-based oligomers. The suspension of silica-based oligomers was prepared by mixing 1 g TEOS, 1 g HCl, 10 g ethanol and then stirring at 700 rpm for 90 min at 60° C. The PMMA substrate was then oxygen plasma (30 W, 0.15 Torr, Harrick Plasma PDC-32G, (Ithaca, N.Y.) treated for 30 s before spin coating. The spin coating speed for S70, S400/S70 and S650/S70 films was 1000 rpm, 750 rpm and 500 rpm, respectively. The spin coated substrates were put in 90° C. oven for 12 h for solvent evaporation.

The morphology of the silica-oligomer hybrid film was analysed using a Field Emission Gun Scanning Electron Microscope (FEG-SEM, Quanta 3D DualBeam, Thermo Fisher Scientific, Waltham, Mass.). Prior to SEM imaging, the superhydrophobic samples were sputtered with a layer of 10 nm platinum (EMS550X Sputter Coater, Electron Microscopy Sciences, Hatfield, Penn.) to improve surface conductivity and reduce the charging effect by shielding the PMMA. The static CAs and sliding angles (SAs) were measured using a VCR Optima goniometer AST Products, Inc., Billerica, Mass.—installed with a droplet shape software by VCA Optima XE, Billerica, Mass.. Static CAs were measured by a sessile drop of 5 μL water droplet onto sample surfaces. SAs was measured by tilting the goniometer stage at a rate of 1 deg/s until a 10 μL droplet rolled off the sample surface. Five different positions on each sample were measured.

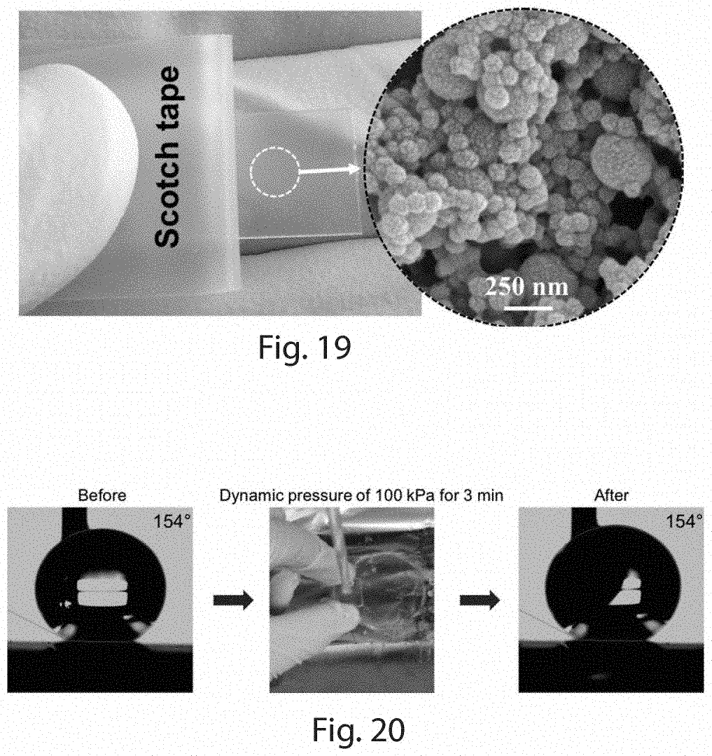

As shown in FIG. 17 and FIG. 18, the PMMA substrate was treated with an oxygen plasma to generate abundant hydroxyl groups. The silica-based oligomer solution strongly acidic, and the synthesized silica particles was known to have large amount of hydroxyl groups. The mixture of silica-based oligomers and silica particles was spin coated on the PMMA substrates. After heat treatment at 90° C. oven for 12 h, the silica-based oligomers formed Si—O—Si bonds between the coatings and substrates to improve surface adhesion. The heat treatment also generated porosities in the coating films that improved surface roughness, as shown in SEM image of FIG. 19.

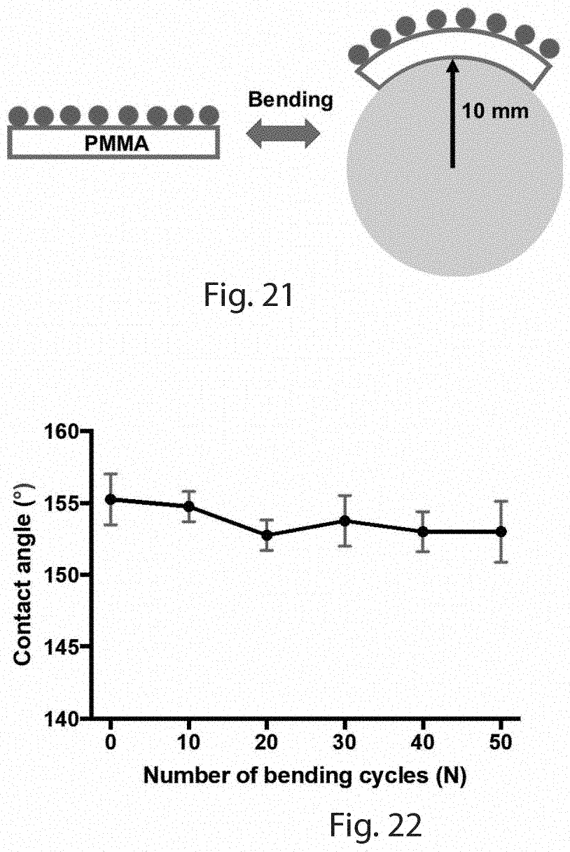

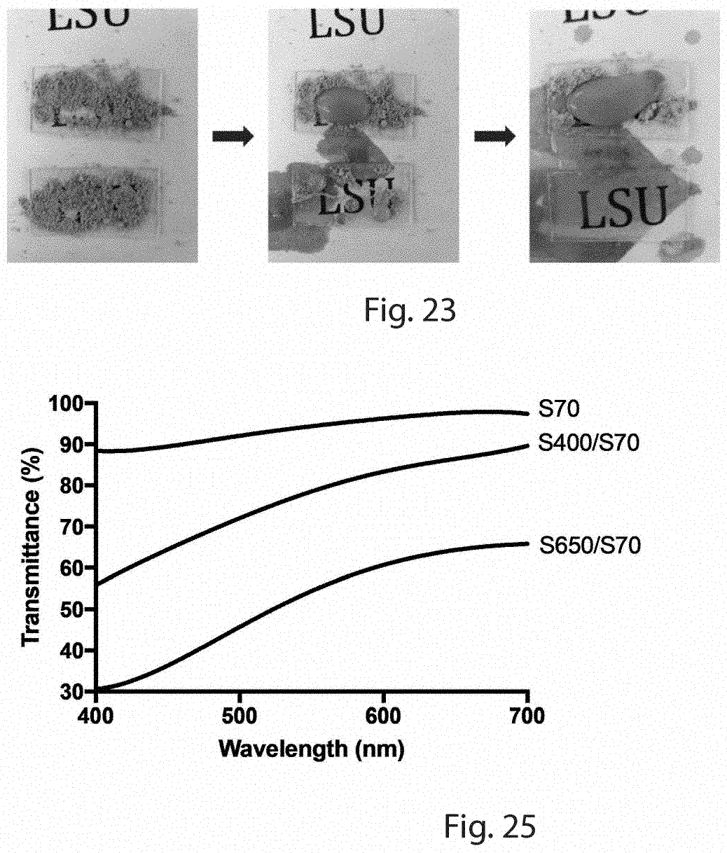

The robustness of the S400/S70 film was tested by peeling off test, water jet impact test, PMMA substrate bending test, and self-cleaning test. FIG. 19. shows the peeling-off test using scotch tape, in which the SEM image shows no S400/S70 nanoparticles were detached from the PMMA substrate. After exposure to tap water jet with pressure around 100 kPa for 3 min, the S400/S70 coated PMMA substrate exhibited the same superhydrophobicity (FIG. 20). The superhythophobicity of S400/S70 coated PMMA substrate was also tested by measuring water contact angles after bending motion (FIG. 21). Superhydrophobicity was well maintained after 50 bending cycles with bending radius of 10 mm (FIG. 22). FIG. 23 shows self-cleaning process on pristine (upper) and S400/S70 (bottom) coated PMMA substrate covered with sandy dust.

FIG. 19 shows the peeling-off test using scotch tape; The SEM image show no S400/S70 nanoparticles were detached from the PMMA substrate.

FIG. 20 shows contact angle images before and after applying water jet. The superhydrophobic film preserved its water contact angle.

FIG. 21 shows S400/S70 coated PMMA substrate under bending with bending radius of 10 mm.

FIG. 22 shows water contact angle as a function of the number of bending cycles for S400/S70 film.

FIG. 23 shows snapshots of the self-cleaning process on pristine (upper) and. S400/S70 (bottom) coated PMMA substrate covered with sandy dust.

For the three silica particle films, the spin coating speed was optimized to be high enough to avoid particle agglomeration, while not too high to avoid insufficient surface coverage. For larger silica particles, it requires a lower spin coating speed to create thicker films for sufficient surface coverage. The spin coating speed for S70, S400/S70 and S650/S70 films was 1000 rpm, 750 rpm and 500 rpm, respectively.

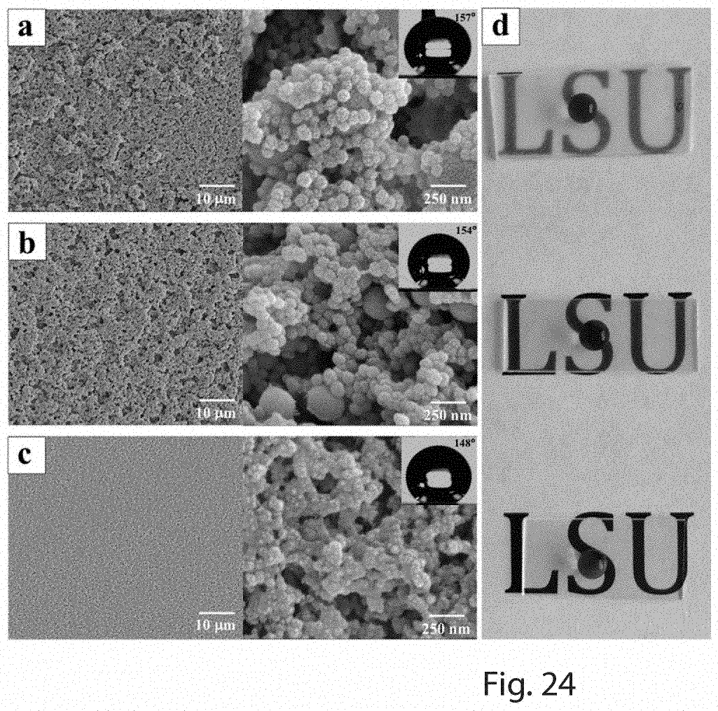

FIG. 24 shows the surface morphology of the three types of films. The S70 film has the highest coating uniformity (as shown in SEM images) and optical transmittance (>89% in the visible wavelength), while it has the lowest water contact angle (CA=148±5°). The S650/S70 films have the highest water contact angle (155±3°) , due to the micro- and nano- hierarchical surface structures. However, the large S650 particles lead to unavoidable particle agglomeration (FIG. 24 image set b). The thicker S650/S70 film also reduced its optical transparency 20±4% compared to S400/S70 film. The S400/70 films were best qualified as uniformness (SEM image in FIG. 24), transparency (Optical transmittance in FIG. 25), superhydrophobic (The static CAs in Table 5) coating on PMMA substrates.

FIG. 24 shows SEM images of S70 (images at a), S400/S70 (images at b) and S650/S70 (images at c) silica films on PMMA substrates, corresponding to the upper, middle, and bottom PMMA substrate of image (image at d).

FIG. 25 shows transmittance spectra in visible wavelength for S70, S400/S70, and S650 films on PMMA substrates. The graph shows the transmittance percentage with respect to the pristine PMMA.

It has been shown that smaller surface structures, thinner coating films achieve higher optical transparency in the visible light wavelengths of 400-700 nm. In the visible range, the silica oxide particles have high transmittance due to low refractive index (n=1.5) and low absorption due to a short band gap wavelength (138 nm). Silica particles are a good potential material for transparent coatings. As shown in FIG. 25, the smaller silica particles have higher optical transparency at visible wavelengths.

Corrosion resistance is essential for superhydrophobic applications in outdoor environments. The corrosion test was conducted by immersing superhydrophobic PMMA substrates in hydrochloric acid or sodium hydroxide solutions for 72 h with pH ranging from 1 to 14. The CAs and SAs under different pH values were shown in the table below.

TABLE 5
Organic-inorganic composite.

| | | Hydrophobicity | | |
|---|---|---|---|---|
| | Uniformness | CA/° | SA/° | Transparency |
| S70 + Acid sol | Excellent | 148 ± 5 | 36 ± 13 | 89-95% |
| S400/S70 + Acid sol | Good | 152 ± 3 | 6 ± 3 | 57-90% |
| S650/S70 + Acid sol | Low | 155 ± 3 | 5 ± 3 | 31-63% |

Uniform, highly transparent, superhydrophobic surfaces were fabricated via spin coating a mixture of silica-based oligomer and single-sized or dual-sized silica particles onto PMMA substrates. SEM images showed the uniformness of the silica coating on the polymer substrates. The transmittance spectra in the visible wavelength demonstrated the high optical transmittance for S70 (89-95%), S400/S70 (57-90%), and S650/570 (31-63%) films. The superhydrophobicity of coating films were shown in terms of static CAs and SAs for S70 (CA=148±5°, SA=36±13°), S400/570 (CA=152±3°, SA=6 ±3°), and S650/S70 (CA=155±3°, SA=5±3°) films.

Three types of coating films were obtained. Silica-based oligomer was added in silica particles to improve the adhesion between the silica particles and the polymer substrates. The S70, S400/S70 and S650/S70 films have their limitations in uniformity, superhydrophobicity and transparency. The S70 films have limited superhydrophobicity due to the single-scaled surface roughness. The dual-sized S650/S70 films have low optical transparency and coating uniformness due to the greater film thickness from S650 microparticles. The S400/S70 film are best suited for uniform, transparent, superhydrophobic coatings and will be used gasketless fluid interconnects.

The above-described embodiments have a number of independently useful individual features that have particular utility when used in combination with one another including combinations of features from embodiments described separately. There are, of course, other alternate embodiments which are obvious from the foregoing descriptions, which are intended to be included within the scope of the present application.

1. A method of preparing a surface comprising:
a. providing a polymeric substrate;
b. providing a silica-based oligomer;
c. providing a first set of nano-scale silica particles;
d. providing a second set of nano-scale silica particles wherein the second set of nano-scale silica particles has mean diameter of at least twice that of a mean diameter of the first set of nano-scale silica particles;
e. providing a solvent;
f simultaneously coating the polymeric substrate with: the silica-based oligomer, the first set of nano-scale silica particles, the second set of nano-scale silica particles and the solvent thereby creating a substrate coating on the polymeric substrate; and
g. applying heat to the substrate coating thereby evaporating the solvent and creating a superhydrophobic surface coating;
h. wherein the superhydrophobic surface coating on the polymeric substrate has an optical transmittance of at least 50% as compared to the untreated polymeric substrate for 600 nm wavelength light; and
i. wherein the superhydrophobic surface coating on the polymeric substrate has a structural integrity sufficient to maintain the superhydrophobic nature of the superhydrophobic surface coating after a tape peel test.

2. The method of preparing a surface of claim 1 wherein the first set of nano-scale silica particles has a mean diameter below 100 nm.

3. The method of preparing a surface of claim 1 wherein the polymeric substrate is poly(methyl methacrylate).

4. The method of preparing a surface of claim 1 wherein the polymeric substrate is polycarbonate.

5. The method of preparing a surface of claim 1 wherein the superhydrophobic surface coating exhibits dual scale roughness.

6. The method of preparing a surface of claim 1 wherein the superhydrophobic surface coating exhibits superior self-cleaning ability as compared to the untreated polymeric substrate.

7. A surface preparation comprising:
a. a polymeric substrate;
b. silica-based oligomers bound to the polymeric substrate;
c. a first set of nano-scale silica particles bound to the silica-based oligomers; and
d. a second set of nano-scale silica particles wherein the second set of nano-scale silica particles has mean diameter of at least twice that of a mean diameter of the first set of nano-scale silica particles and wherein the second set of nano-scale silica particles is bound to the silica-based oligomers;
e. wherein the silica-based oligomers, the first set of nano-scale silica particles, and the second set of nano-scale silica particles combine to form a superhydrophobic surface coating over the polymeric substrate;
f wherein the superhydrophobic surface coating over the polymeric substrate has an optical transmittance of at least 50% as compared to the untreated polymeric substrate for 600 nm wavelength light; and
g. wherein the superhydrophobic surface coating on the polymeric substrate has a structural integrity sufficient to maintain the superhydrophobic nature of the superhydrophobic surface coating after a tape peel test.

8. The surface preparation of claim 7 wherein the first set of nano-scale silica particles has a mean diameter below 100 nm.

9. The surface preparation of claim 7 wherein the polymeric substrate is poly(methyl methacrylate).

10. The surface preparation of claim 7 wherein the polymeric substrate is polycarbonate.

11. The surface preparation of claim 7 wherein the superhydrophobic surface coating exhibits dual scale roughness.

12. The surface preparation of claim 7 wherein the superhydrophobic surface coating exhibits superior self-cleaning ability as compared to the untreated polymeric substrate.
